(19) United States
(12) Patent Application Publication
(10) Pub. No.: US 2014/0268805 A1
(43) Pub. Date: Sep. 18, 2014

(54) ILLUMINATING DEVICE

(71) Applicant: Yan Qian LIN, Taipei (TW)

(72) Inventor: Yan Qian LIN, Taipei (TW)

(73) Assignee: Yan Qian LIN, Taipei (TW)

(21) Appl. No.: 13/802,967

(22) Filed: Mar. 14, 2013

(51) Int. Cl. F21V 7/04

(52) U.S. Cl. CPC F21V 7/04
USPC 362/296.05

(57) ABSTRACT

An illuminating device includes a hood having a bottom wall and an outer peripheral wall which includes a curved reflective surface, a light device includes a light element attached to a circuit board and electrically connected to an electric cable, and a fastening device is disposed or engaged between the bottom wall of the hood and the circuit board of the light device for selectively securing the circuit board of the light device to the bottom wall of the hood. The fastening device includes one or more magnetic attractive members attached to the bottom wall of the hood, and one or more fastening members attached to the magnetic attractive members and engaged with the circuit board of the light device.

### BACKGROUND OF THE INVENTION

1. Field of the Invention

The present invention relates to an illuminating device, and more particularly to an illuminating device including a simplified or reduced structure or configuration for allowing the illuminating device to be easily and quickly and readily made or manufactured and assembled with a greatly reduced or decreased manufacturing cost.

2. Description of the Prior Art

Typical illuminating devices or LED (Light Emitting Diode) light assemblies or devices comprise a receptacle or housing for attaching or mounting or securing or engaged into a ceiling or other supporting surfaces or objects, and one or more circuit boards disposed or attached or mounted or secured in the housing and including a number of LED light members for generating lights with reduced electric energy and cost.

For example, U.S. Pat. No. 7,645,052 to Villard, U.S. Pat. No. 7,690,809 to Tsai et al., U.S. Pat. No. 7,931,517 to Yang et al., and U.S. Pat. No. 7,954,975 to Zhou disclose several of the typical LED light assemblies or devices each also comprising a number of LED light members received or engaged in and attached or mounted or secured in an outer housing for attaching or mounting or securing or engaged into a ceiling, and for generating lights with less electric energy.

However, the illuminating devices or light assemblies or devices comprise a complicated structure or configuration including a number of parts or elements that may not be easily and quickly and readily made or manufactured and assembled by workers and that may include a number of manufacturing and assembling procedures and that may include a greatly increased manufacturing cost.

The present invention has arisen to mitigate and/or obviate the afore-described disadvantages of the conventional illuminating devices.

### SUMMARY OF THE INVENTION

The primary objective of the present invention is to provide an illuminating device including a simplified or reduced structure or configuration for allowing the illuminating device to be easily and quickly and readily made or manufactured and assembled with a greatly reduced or decreased manufacturing cost.

In accordance with one aspect of the invention, there is provided an illuminating device comprising a hood including a chamber formed therein and defined by a bottom wall and an outer peripheral wall, the outer peripheral wall of the hood including a curved structure having an inner reflective surface formed therein for light reflective purposes, a light device including a circuit board, and a light element attached to the circuit board and electrically connected to an electric cable, and a fastening device disposed or engaged between the bottom wall of the hood and the circuit board of the light device for selectively securing the circuit board of the light device to the bottom wall of the hood, and the illuminating device includes a simplified or reduced structure or configuration that may be easily and quickly and readily made or manufactured and assembled with a greatly reduced or decreased manufacturing cost.

The hood includes an orifice formed in the bottom wall of the hood and communicating with the chamber of the hood for receiving and engaging with the electric cable and for connecting or coupling to the electric power sources or the like. The fastening device includes at least one magnetic attractive member attached to the bottom wall of the hood for selectively attracting the circuit board of the light device to the bottom wall of the hood.

The fastening device includes at least one fastening member attached to the magnetic attractive member and engaged with the circuit board of the light device for selectively fastening or securing the circuit board of the light device to the bottom wall of the hood, for example, the fastening member may selected from an adhesive material, a tape, or a hook and loop fastening device, or a double-sided adhesive member or the like for easily and quickly and readily attaching or mounting or securing or coupling the circuit board of the light device to the bottom wall of the hood.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of an illuminating device in accordance with the present invention;

FIG. 2 is a perspective view of the illuminating device; and

FIG. 3 is a cross sectional view of the illuminating device, taken along lines 3-3 of FIG. 2.

### DETAILED DESCRIPTION OF THE PREFERRED EMBODIMENT

Referring to the drawings, an illuminating device in accordance with the present invention comprises a bowl-shaped lamp shade or hood 10 including a chamber 11 formed therein and formed or defined by a bottom wall or panel 12 and an outer peripheral wall or panel 13, in which the outer peripheral wall 13 of the hood 10 includes a curved structure or configuration having an inner reflective surface 14 formed therein for light reflective purposes, the hood 10 is made of magnet or magnetic attractive materials and further includes an orifice 15 formed in the bottom wall 12 thereof and communicating with the chamber 11 of the hood 10. A fastening device 2 includes one or more (such as two) magnet or magnetic attractive members 20 attracted or attached or mounted or secured to the bottom wall 12 of the hood 10 with the magnetic attractive force, and one or more (such as two) fastening members 21 attached or mounted or secured to the magnetic attractive members 20 respectively.

The illuminating device further comprises a light member or device 3 including a circuit board 30 made of non-magnetic attractive materials, such as aluminum materials, and one or more light members or elements 31 attached or mounted or secured onto the circuit board 30 and electrically connected or coupled to an electric wire or cable 42 which is engaged through the orifice 15 of the bottom wall 12 of the hood 10 for connecting or coupling to the electric power sources or the like. The fastening members 21 and/or the magnetic attractive members 20 of the fastening device 2 are disposed or engaged between the bottom wall 12 of the hood 10 and the circuit board 30 of the light device 3 for selectively attaching or mounting or securing or coupling the circuit board 30 of the light device 3 to the bottom wall 12 of the hood 10.

The circuit board 30 that is made of non-magnetic attractive materials may not be attracted or secured to the bottom wall 12 of the hood 10 with the magnetic attractive force of the magnetic attractive members 20, but may be attached or mounted or secured to the bottom wall 12 of the hood 10 directly with the fastening members 21 and/or indirectly with the magnetic attractive members 20, in which the fastening members 21 may be selected from an adhesive material, a tape, a Velcro or hook and loop fastening device, a double-sided adhesive member or the like, and may be used to adhere or to attach or to mount or to secure the circuit board 30 of the light device 3 to the bottom wall 12 of the hood 10 directly without the magnetic attractive members 20.

It is to be noted that the illuminating device in accordance with the present invention comprises a simplified or reduced structure or configuration having fewer parts or elements, such as the hood 10 and the circuit board 30 of the light device 3, and either or both the magnetic attractive members 20 and the fastening members 21 for easily and quickly and readily attaching or mounting or securing or coupling the circuit board 30 of the light device 3 to the bottom wall 12 of the hood 10, such that the illuminating device in accordance with the present invention may be easily and quickly and readily made or manufactured and assembled by workers and may include a simplified manufacturing and assembling procedure and may be made with a greatly increased manufacturing cost. The inner reflective surface 14 of the outer peripheral wall 13 of the hood 10 may be used to suitably reflect the lights.

Accordingly, the illuminating device in accordance with the present invention includes a simplified or reduced structure or configuration for allowing the illuminating device to be easily and quickly and readily made or manufactured and assembled with a greatly reduced or decreased manufacturing cost.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An illuminating device comprising:
a hood including a chamber formed therein and defined by a bottom wall and an outer peripheral wall, said outer peripheral wall of said hood including a curved structure having an inner reflective surface formed therein for light reflective purposes,
a light device including a circuit board, and a light element attached to said circuit board and electrically connected to an electric cable, and
a fastening device disposed and engaged between said bottom wall of said hood and said circuit board of said light device for selectively securing said circuit board of said light device to said bottom wall of said hood.

2. The illuminating device as claimed in claim 1, wherein said hood includes an orifice formed in said bottom wall of said hood and communicating with said chamber of said hood for receiving and engaging with said electric cable.

3. The illuminating device as claimed in claim 1, wherein said fastening device includes at least one magnetic attractive member attached to said bottom wall of said hood.

4. The illuminating device as claimed in claim 3, wherein said fastening device includes at least one fastening member attached to said at least one magnetic attractive member and engaged with said circuit board of said light device.

5. The illuminating device as claimed in claim 4, wherein said at least one fastening member is selected from an adhesive material, a tape, or a hook and loop fastening device.
